(19) United States
(12) Patent Application Publication
(10) Pub. No.: US 2002/0105615 A1
(43) Pub. Date: Aug. 8, 2002

(54) Display device

(75) Inventor: Nicolaas Aldegonda Jan Maria Van Aerle, Heerlen (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/067,043

(22) Filed: Feb. 4, 2002

(30) Foreign Application Priority Data
Feb. 8, 2001 (EP) 01200466.9

(51) Int. Cl. G02F 1/1345

(52) U.S. Cl. 349/151

(57) ABSTRACT

By placing the contact region for contacting row lines along a side parallel to the side having a contact region for contacting column lines, the border of the LC device can be omitted and the display area in one direction can be maximized, for example, up to the inner dimension of a housing.

The invention relates to a display device comprising a first and a second substrate between which a plurality of pixels is provided, the substrates comprising at least a first group of electrodes and a further group of electrodes for driving the pixels via switching elements, the electrodes or connection conductors for the electrodes extending as far as connections proximate to a first part of the edge of the first substrate.

The invention also relates to a display device comprising a first and a second substrate between which a plurality of pixels is provided, the first substrate comprising at least a group of electrodes for driving the pixels via switching elements, the electrodes extending as far as connections proximate to parallel parts of the edge of the first substrate.

Said display devices are used in, for example, GSM telephones but also in other portable applications, for example, as viewfinders in video cameras, and in organizers. Examples of such display devices are liquid crystal display devices (LCD) and (polymer) LED display devices but also, for example, parts of display devices based on field emission, switching mirrors, electrophoresis, etc.

Display devices of the type described above are provided with display screens (for example, LCD cells) for displaying information by means of electro-optical display media such as liquid crystals, electrophoretic suspensions and electrochromic materials. The known display device usually comprises a system of pixels arranged in rows and columns, while (picture) electrodes, which are arranged on a substrate, correspond to each pixel. For presenting selection and data signals to the pixels, groups of electrodes are arranged on the substrate. These groups of electrodes are usually divided into row electrodes or selection electrodes and column electrodes or data electrodes which are usually arranged in a matrix configuration. In the case of active drive, switching elements (thin-film transistors) are situated at the location of the crossings of row electrodes and column electrodes, which switching elements are selected by means of the row electrodes. To provide the row electrodes and column electrodes with the correct selection voltages and data voltages, drive ICs are usually arranged along the edges on said substrate (or foils with ICs). In a matrix structure of pixels, these are present, for example, along two mutually perpendicular sides of the actual display section. This is at the expense of the substrate surface required for the display device.

This limits, for example, the maximum width of the actual display screen in a mobile telephone. Since one (or more) edge(s) with drive ICs must be taken into account, the width of the housing (in this example, of the telephone) must be chosen to be larger than the width of the actual display screen. Moreover, the ICs have a given height so that no other functional elements such as knobs, keys, etc. can be realized at the location of these ICs.

During the manufacture of substrates on which a group of electrodes is arranged, electrostatic charge or discharge may also take place. Such a voltage difference may then be produced between electrodes of the group of electrodes that breakdown occurs between the electrodes, which may damage the electrodes and switching elements, for example, TFTs. Due to such damage, given pixels (or rows and/or columns of pixels) can no longer be driven so that the quality of the displayed image is detrimentally influenced. Electric breakdown or flashover between the electrodes results in rejection of the display device. The further the manufacture of the display device has progressed, for example, up to the test phase, the more costly the damage and consequent rejection due to electrostatic discharge will be.

A drawback of the known display device is that a large number of (extra) switching elements is required to reduce electrostatic discharge. Such (extra) switching elements increase the complexity of the design and are themselves a possible source of rejection.

It is an object of the invention to provide a display device of the type described in the opening paragraph, in which the substrates have a minimal surface area so that a minimal quantity of substrate material (glass, synthetic material) is lost during manufacture of the display devices.

It is a further object to provide such a display device in which damage due to electrostatic discharge is avoided as much as possible and in a simple manner.

To this end, in a display device according to the invention, electrodes of the group of electrodes or connection conductors for the further group of electrodes extend as far as connections proximate to a first part of the edge (or as far as connections proximate to parallel parts of the edge) of the first substrate, and a further part of the edge of the first substrate, viewed in a direction transverse to the substrates, substantially coincides with a further, corresponding part of the edge of the second substrate.

The invention is based on the recognition that, due to the fact that the group of electrodes and connection conductors for the further group of electrodes are now contacted along one part of the edge (or two parallel parts), it is no longer necessary to reserve any space for the contacts along other parts of the edge so that the substrate space can be utilized optimally in at least one dimension. Notably when the edges are substantially rectangular and the further parts of the edges of the first and the second substrate correspond to two parallel extending sides of the rectangle, no or hardly any tolerances need to be taken into account in the direction transverse to these sides and much less substrate material is lost, particularly in the manufacture of smaller display devices. Moreover, an arbitrary shape, for example, a circular shape may now be chosen in a simple manner for the further part.

It is to be noted that contacting, for example, row and column electrodes on one side is known per se from the article “Manufacturing of Large Wide-View Angle Seamless Tiled AMLCDs for Business and Consumer Applications”, IDMC 2000, pp. 191-193. However, this article only emphasizes the advantages of the feature of connection on one side and its advantages in a process referred to as “tiling” of a plurality of display components. The additional advantages of such a way of connection in the manufacture of single display devices, namely the mutual positioning of the substrates without substantially any tolerance on remaining parts of the edge, are not recognized at all in this article.

These and other aspects of the invention are apparent from and will be elucidated with reference to the embodiments described hereinafter.

In the drawings:

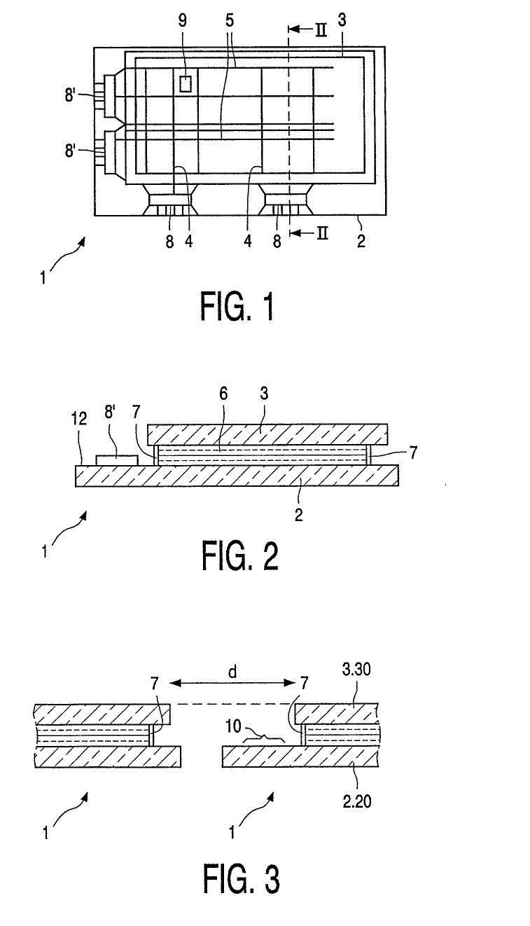

FIG. 1 is a diagrammatic plan view of a conventional display device,

FIG. 2 is a diagrammatic cross-section of a part of the liquid crystal display device (LCD), taken on the line II-II in FIG. 1,

FIG. 3 shows diagrammatically a step of manufacturing a part of the display device of FIG. 2,

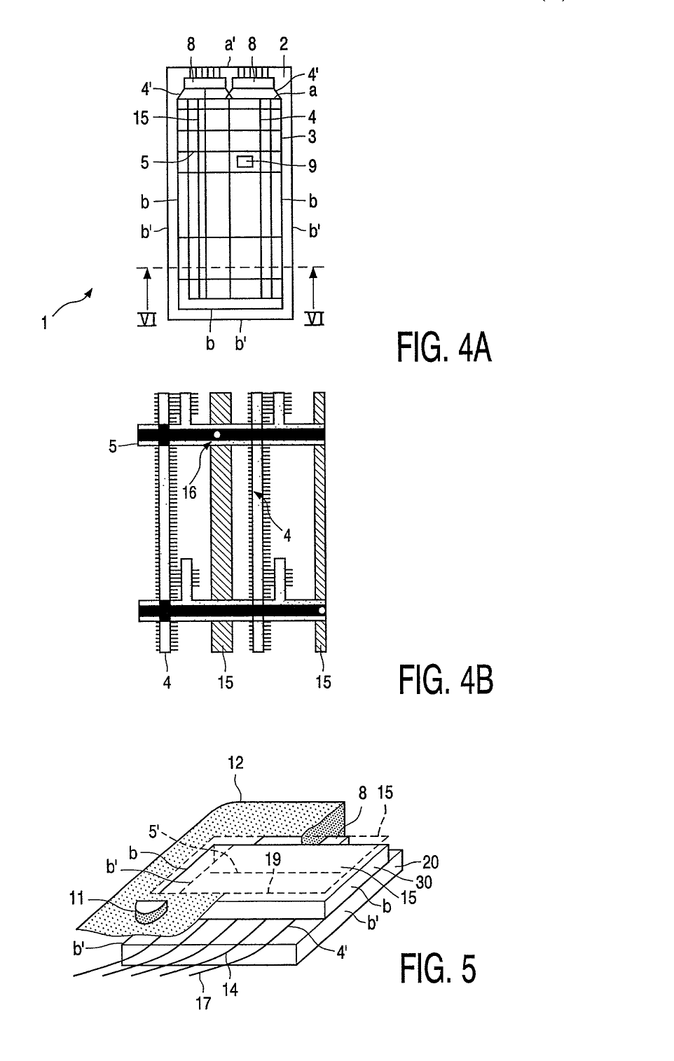

FIG. 4 is a diagrammatic plan view of a part of a liquid crystal display device (LCD) according to the invention, while

FIG. 5 is a diagrammatic elevational view of a variant of the device of FIG. 4,

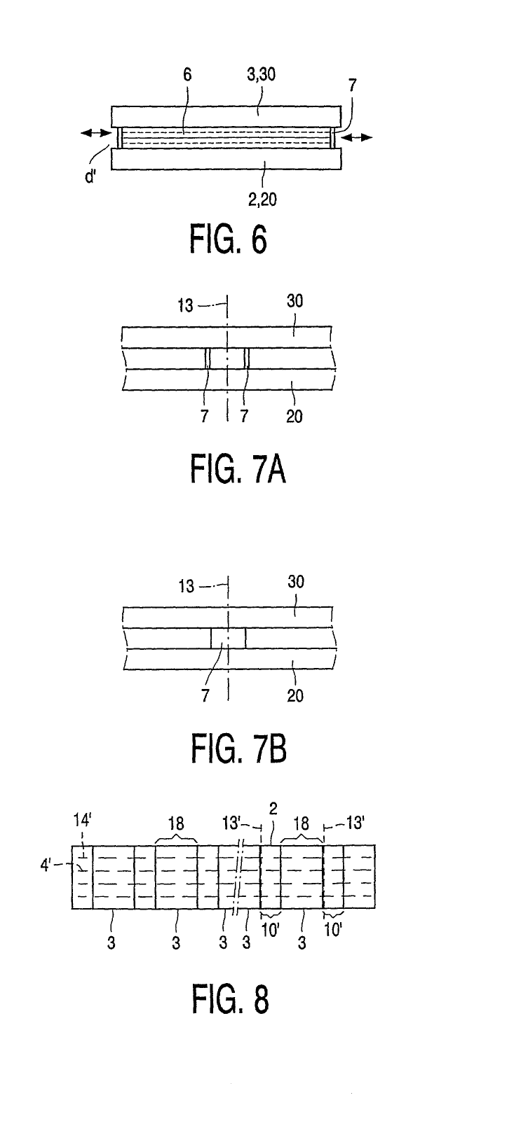

FIG. 6 is a diagrammatic cross-section taken on the line VI-VI in FIG. 4A, while

FIG. 7 shows a step of manufacturing the display device of FIG. 6, and

FIG. 8 shows a plurality of cells in the manufacturing stage.

The Figures are diagrammatic and not drawn to scale. For the sake of clarity, some dimensions are strongly exaggerated. Similar components in the Figures are denoted as much as possible by the same reference numerals.

FIG. 1 is a very diagrammatic plan view of a conventional display device 1 of the flat type. The display device comprises a first substrate 2 which is provided with a pattern of pixels 9 which, in this example, are separated from each other at a predetermined distance in the vertical and the horizontal direction. Each pixel 9 is present at the area of the crossing of electrodes 4, arranged in vertical columns, from a group of electrodes, and electrodes 5, arranged in horizontal rows, from a further group of electrodes. The electrodes 4 from the group of electrodes are also referred to as column electrodes, and the electrodes 5 from the further group of electrodes are also referred to as row electrodes. The pixels are selected in generally known manner and provided with data via thin-film transistors (TFTs) not shown in FIG. 1.

Electrodes 4 receive data drive signals from a drive circuit 8 and electrodes 5 receive select signals from a drive circuit 8′.

To realize an image or a data-graphic display on a relevant area of the surface of substrate 2, the display device makes use of a scan control circuit which is integrated in, a for example, the drive circuits 8, 8′. Various types of electro-optical materials may be used in the display device. When, for example, a material is used whose state of polarization of the incident light changes, the display device is placed between a pair of polarizers.

FIG. 2 is a diagrammatic cross-section, taken on the line II-III, of a part of the display device of FIG. 1, in this example a liquid crystal display device (LCD) which comprises a first substrate 2 and a second substrate 3 between which, for example, a twisted nematic or ferroelectric liquid crystalline material 6 is present. The assembly is sealed in generally known manner by means of a sealing rim 7 having a filling aperture (not shown). If necessary, the inner surfaces of the substrates 2 and 3 are provided with electric layers (not shown) and chemically insulating layers. It is to be noted that the surface 12 of the first substrate 2 is larger than that of the substrate 3, inter alia, due to the presence of the drive circuits 8, 8′. This does not only apply to the cross-section of FIG. 2 but also to a cross-section perpendicular to that of FIG. 2. The overlapping parts of the substrates 2, 3 define the actual display section (within which liquid crystal material is present in this example). The LCD may be of the reflective or transmissive type.

Parts of such LCDs (cells) are usually manufactured in larger quantities between two glass plates 20, 30. For the purpose of filling, (rows of) unsplit individual cells are obtained by means of a process referred to as “scratching and breaking”. To realize a maximal output during the breaking process, a given minimum distance (indicated by the double arrow d in FIG. 3) must be taken into account, which distance is 3 to 6 mm in the conventional processes. The distance also depends on a possible space, indicated by means of braces 10 for the ICs 8 or for contacts (for example, via tape carrier packaging or with a flexible foil). It will be evident that much glass will be lost in this process.

In the device according to the invention, as shown in FIG. 4, vertical column electrodes 4 extend (in this example) on the first substrate 2, which column electrodes extend as far as a first part (a) of an edge of the substrate 3 and join connection conductors 4′ which are supplied with the required voltages by means of drive ICs 8 for driving the pixels 9. The drive ICs 8 are also present on the substrate 2. In the horizontal direction, row electrodes 5 extend (in this example) on the substrate 2, which row electrodes contact vertically extending connection conductors 15 (which are transparent in this example) via through-connections or vias 16 (see the plan view in FIG. 4B), which connection conductors are also supplied with the required voltages by means of the drive ICs 8 for driving the pixels 9. The part b of the edge of the substrate 3 now substantially coincides with the corresponding part b′ of the substrate 2.

A vertically extending connection conductor 15 (transparent in this example), which extends parallel to the vertical column electrodes 4, corresponds to each row electrode 5. The connection conductors 15 also extend as far as the first part (a) of the edge of the substrate 3 and join connection conductors 4′ which are supplied with the required voltages by means of drive ICs 8.

Since all connections to the column electrodes and the row electrodes are now present (via the connection conductors 15) on the part of the substrate proximate to the edge a of the substrate, the tolerances as indicated in FIG. 3 by means of the double arrow d no longer need to be taken into account, at least in one direction, in the device of FIG. 4A.

The same applies to another embodiment which is shown in an elevational view in FIG. 5. Now, for example, the row electrodes are provided with row selection signals (by means of IC 8) via connection conductors 15 which are similar to those in FIGS. 4A,B, while data signals are presented to column electrodes 4 by means of a flexible foil 17. The foil 17 is provided with conductor tracks 14 which (possibly via conductors 4′) supply the column electrodes with voltages. Such a structure is very suitable for mobile (handheld) applications because the usable surface area for the image (shown by way of broken lines 19 in FIG. 5) is maximal in the direction of the row electrodes so that a maximum control length is obtained. In principle, the edges b, b′ can substantially coincide with the inner wall of the housing 12, for example, because the substrates 2, 3 are clamped, as it were, in the housing, while pressure contacts 11 (for example, telephone keys just underneath the image) at the location of the electrodes 4′ can be placed substantially against the cell without these pressure contacts or connections connected thereto disturbing the functionality of the connections 4′ or of the conductors 14.

This ensures a considerably more economical use of glass, as is shown in FIG. 6. Now, tolerances (indicated by the double arrow d′ in FIG. 5) must be taken into account, which tolerances are mainly determined by small dimensions of the lines along which “scratching and breaking” takes place (line 13 in FIG. 7A). The cutting line 13 may then be situated between the sealing rims 7 but also intersect it, as is shown in FIG. 7B).

Since the external connection conductors 4′, 15′(FIG. 5) are parallel, they can be jointly formed, i.e. as continuous conductors 4, 4′ and 15, 15′ for more cells in one track, as is shown diagrammatically in FIG. 8 (the cells are at the area of the braces 18 and are separated by border areas 10). The complete row of cells can now be provided with test patterns from two sides (in this example) or from one side (as in FIG. 4A). Corresponding pixels in the various cells react (become light or dark in the case of liquid crystal cells, luminesce in the case of LEDs), which is optically registered (simultaneously). This allows rapid testing, while the risk of electrostatic breakdown is considerably reduced in this manufacturing stage.

The invention is of course not limited to the embodiments shown. Notably, connection on one side is favorable in applications in which a display is inserted into a connector block, or in applications in which the active area (the display section) has an unusual shape, for example, (semi)circular. Various types of synthetic material may be used for the substrates, so that the invention is also very suitable for wearable displays. The invention is neither limited to liquid crystal display devices, but display devices based on, for example, field emission, electroluminescence, switchable (hydrid) mirrors, etc. are also feasible.

The ICs do not necessarily have to be mounted on the glass. They may be provided on tape or foil if use is made of COF (Chip on Foil) or TCP (Tape Carrier Package) techniques.

A second substrate is not always present in a number of possible effects for picture display. The invention is also applicable to these types of display devices.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device comprising a first and a second substrate between which a plurality of pixels is provided, the substrates comprising at least a first group of electrodes and a further group of electrodes for driving the pixels via switching elements, the electrodes or connection conductors for the electrodes extending as far as connections proximate to a first part of the edge of the first substrate, and a further part of the edge of the first substrate, viewed in a direction transverse to the substrates, substantially coinciding with a further, corresponding part of the edge of the second substrate.

2. A display device comprising a first and a second substrate between which a plurality of pixel elements is provided, the substrates comprising at least a first group of electrodes and a further group of electrodes for driving the pixels via switching elements, the electrodes or connection conductors for the electrodes extending as far as connections proximate to parallel parts of the edge of the first substrate, and a further part of the edge of the first substrate, viewed in a direction transverse to the substrates, substantially coinciding with a further, corresponding part of the edge of the second substrate.

3. A display device as claimed in claim 1 or 2, wherein the edge of the first substrate is provided with drive electronics.

4. A display device as claimed in claim 1 or 2, wherein the connections for the group of electrodes and for the connection conductors for the further group of electrodes are present at the location of the first part of the edge of the first substrate.

5. A display device as claimed in claim 1 or 2, wherein the edges have a substantially rectangular shape, and the further parts of the edges of the first substrate correspond to two parallel extending sides of the rectangle.

6. A display device as claimed in claim 5, wherein the distance between the two parallel extending sides of the rectangles is not more than 10 cm.

7. A display device as claimed in claim 5, wherein the distance between the two parallel extending sides of the rectangles is not more than 7 cm.

8. A display device as claimed in claim 5, wherein the parallel extending sides substantially coincide with an inner wall of a housing of the display device.

9. A display device as claimed in claim 5, wherein the display device comprises an electro-optical medium between the substrates.

10. A display device comprising a first substrate provided with parts of a plurality of pixels, the display device comprising at least a first group of electrodes and a further group of electrodes for driving the pixels via switching elements, the electrodes or connection conductors for the electrodes extending as far as connections proximate to parallel parts of the edge of the first substrate.

11. A display device as claimed in claim 10, wherein the edges have a substantially rectangular shape, and the further parts of the edges of the first substrate correspond to two parallel extending sides of the rectangle.

12. A display device as claimed in claim 11, wherein the distance between the two parallel extending sides of the rectangles is not more than 10 cm.

13. A display device as claimed in claim 11, wherein the distance between the two parallel extending sides of the rectangles is not more than 7 cm.

14. A display device as claimed in claim 11, wherein the parallel extending sides substantially coincide with an inner wall of a housing of the display device.
